(19) United States
(12) Patent Application Publication
(10) Pub. No.: US 2016/0232541 A1
(43) Pub. Date: Aug. 11, 2016

(54) USING SOURCE DATA TO PREDICT AND DETECT SOFTWARE DEPLOYMENT AND SHELFWARE

(71) Applicant: International Business Machines Corporation, Armonk, NY (US)

(72) Inventors: Jennifer G. Becker, New Hill, NC (US); Jarett Stein, Bryn Mawr, PA (US)

(21) Appl. No.: 15/055,655

(22) Filed: Feb. 29, 2016

Related U.S. Application Data
(63) Continuation of application No. 14/618,543, filed on Feb. 10, 2015.

(51) Int. Cl. G06Q 30/02; G06F 17/30

(52) U.S. Cl. CPC G06Q 30/0201; G06F 17/30339

(57) ABSTRACT

Detecting the presence of shelfware. A licensing data table and an exported business data table are received from a business data source, wherein a plurality of data fields associated with a plurality of business categories are included. A plurality of dimensions are created based on a common data attribute among the plurality of data fields. The received licensing data table and the received exported business data table are structured by assigning each data field within the plurality of data fields to a dimension within the plurality of dimensions. A fact table for each of the plurality of business categories is populated for each of the plurality of business categories. The populated fact tables are merged based on a predetermined usefulness when detecting shelfware. A dimensional model is constructed. An interpretative report is built to display a plurality of customer-related information based on the constructed dimensional model.

### BACKGROUND

The present invention generally relates to the field of computing, and more particularly to software deployment and shelfware.

Software purchases may be one of the biggest expenses experienced by businesses. Furthermore, many software purchasers may not fully deploy purchased software and, therefore, possess shelfware. Software deployment relates to software that has been installed or licenses that have been activated for use by a software purchaser. Conversely, shelfware describes purchased or licensed software that may have been acquired due to a perceived need by the purchaser however the purchaser does not actually utilize the purchased software. For example, if a business purchases 100 licenses of software to use in the normal course of business and only 80 of the 100 purchased licenses are activated by the business, then 20 licenses remain inactive and may be classified as shelfware.

### SUMMARY

Embodiments of the present invention disclose a method for detecting the presence of shelfware. A licensing data table and an exported business data table are received from a business data source. The licensing data table and the exported business data table include a plurality of data fields associated with a plurality of business categories. The plurality of business categories comprises licensing data and sales data. A plurality of dimensions are created based on a common data attribute among the plurality of data fields. The plurality of dimensions includes a data ID, a customer ID, and a product ID. The common data attribute includes a plurality of enterprise numbers, a plurality of international account numbers, a plurality of part numbers, a plurality of product family numbers, and a plurality of product identification numbers. The received licensing data table and the received exported business data table are structured by assigning each data field within the plurality of data fields to a dimension within the created plurality of dimensions. A fact table for each of the plurality of business categories with each data field within the plurality of data fields is populated based on each of the plurality of business categories from which each data field originated. The exported business data table comprises at least one of a license data table and a sales data table. The populated fact table for each of the plurality of business categories are merged based on a predetermined usefulness of each populated fact table when detecting shelfware. The populated fact table for each of the plurality of business categories contains a plurality of measurement information. The plurality of measurement information comprises at least one of a plurality of revenue numbers, a plurality of license entitlements, and a plurality of license activations. A dimensional model is constructed based on the merging the populated fact table for each of the plurality of business categories, the populated fact table for each of the plurality of business categories, and each data field within the structured licensing data table and the structured exported business data table. An interpretative report is built to display a plurality of customer-related information based on the constructed dimensional model. The plurality of customer-related information includes a plurality of license entitlements versus a plurality of license activations.

### BRIEF DESCRIPTION OF THE SEVERAL VIEWS OF THE DRAWINGS

FIG. 1 illustrates a functional block diagram of a shelfware prediction system according to one embodiment of the invention.

FIG. 2 is a flow chart illustrating the operational steps carried out by the shelfware prediction program of the shelfware prediction system of FIG. 1, in accordance with an embodiment of the invention.

FIG. 3 illustrates a data transformation according to one embodiment of the invention.

FIG. 4 illustrates merging grouped data into a fact table according to one embodiment of the invention.

FIG. 5 illustrates a merged fact table according to one embodiment of the invention.

FIG. 6 illustrates a merged fact table with blank data fields according to one embodiment of the invention.

FIGS. 7A-7D illustrate a shelfware report identifying products and customers in accordance with one embodiment of the invention.

FIG. 8 is a block diagram of internal and external components of the computers and servers depicted in FIG. 1 according to one embodiment of the invention.

### DETAILED DESCRIPTION

Embodiments of the present invention are directed to a shelfware detection system for detecting potential shelfware in an enterprise environment in an automated and programmatic fashion. Such information may be useful in identifying key services and sales opportunities.

Limiting the presence of shelfware may be vital for a software purchaser to achieve a return on investment for purchased software. Furthermore, many software developers and distributors may encounter similar issues with software deployment and shelfware due to possible product reversals and returns that may affect revenue. As such, it may be advantageous, among other things, to determine key services and sales opportunities by identifying potential shelfware customers in an automated and programmatic fashion.

According to one embodiment, various data sources, such as enterprise management systems, license entitlement systems, license management systems, license enforcement systems, compliance systems, customer support systems, sales data systems, and financial data systems, may export data relating to different business areas, such as support, sales, and licensing. Source data, such as licensing data, sales data, financial data, support data, and other exported business data, from the various business areas may assist in identifying patterns and trends that may indicate shelfware and software deployment. For example, support data may be harvested and correlated to sales data and client details in order to identify patterns and trends, such as lack of increase in problem management records or the number of help desk tickets submitted by a client that recently purchased a large amount of software. As an additional example, licensing data may be collected and analyzed to determine the number of active or inactive licenses associated with a particular client. Following a client purchase of software, the number of inactive licenses may be logically associated with the potential presence of shelfware. Additionally since the various data sources may be already export the source data to other locations and/or systems, the source data may be passively collected. Passive collection means source data exported by the various data sources may also be sent to an embodiment of the shelfware detection system from the various data sources without additional special processing requirements on the various data sources. In other embodiments, the source data may be specifically collected on the various data sources, and exported to the shelfware detection system.

Filtering the collected data may identify specific patterns or trends. For example, a client may tender $500,000 for 100 active licenses of a software product. Over time, the client may only activate two licenses and never report support issues. Two scenarios may arise from this data. First, revenue may be at risk of being credited, if the purchaser returns any purchased product. Second, the seller may have the opportunity to conduct deployment engagement activities, such as on-site training, with the client in order to reduce the amount of shelfware. Without passively collecting client source data and recognizing the patterns and trends exhibited by the source data, the seller may be unaware of potential shelfware presence.

Since the source data produced by the various systems may contain vast amounts of data and marrying the data from different business areas may be problematic, manual aggregation of the source data may not be practical due to time and resource constraints. Additionally, since software purchased by a client in one location may be distributed for use to different locations worldwide, manual detection of software deployment may be difficult. Therefore, the embodiments of the present invention may have the capacity to improve the technical field of software deployment detection and shelfware detection by automatically importing, correlating, and filtering the imported source data to identify patterns and trends that may infer installation and usage of purchased software.

The following described exemplary embodiments provide a system, method, and program product to predict and detect the presence of software deployments and shelfware using passively collected source data. Data, such as support data, license data, sales data, and financial data, from various sources within a business enterprise may be correlated. The present embodiment may focus on patterns within the customer-related information or data, such as purchasing trends, license downloads, and support interactions. The patterns and trends may become apparent after establishing complex mappings of the data that may illustrate relationships between the data as existed at the data source. The present embodiment may identify patterns and trends by comparing groupings of data. Additionally, the complex mappings may assist in identifying shelfware patterns and trends across customers that use different identifiers for different interactions. Similarly, the complex mappings may enable the ability to identify patterns and trends between products where the products may implement different identifiers within different systems. Without the complex mapping between groupings of customers and products, shelfware patterns and trends may not be identified between such disparate systems.

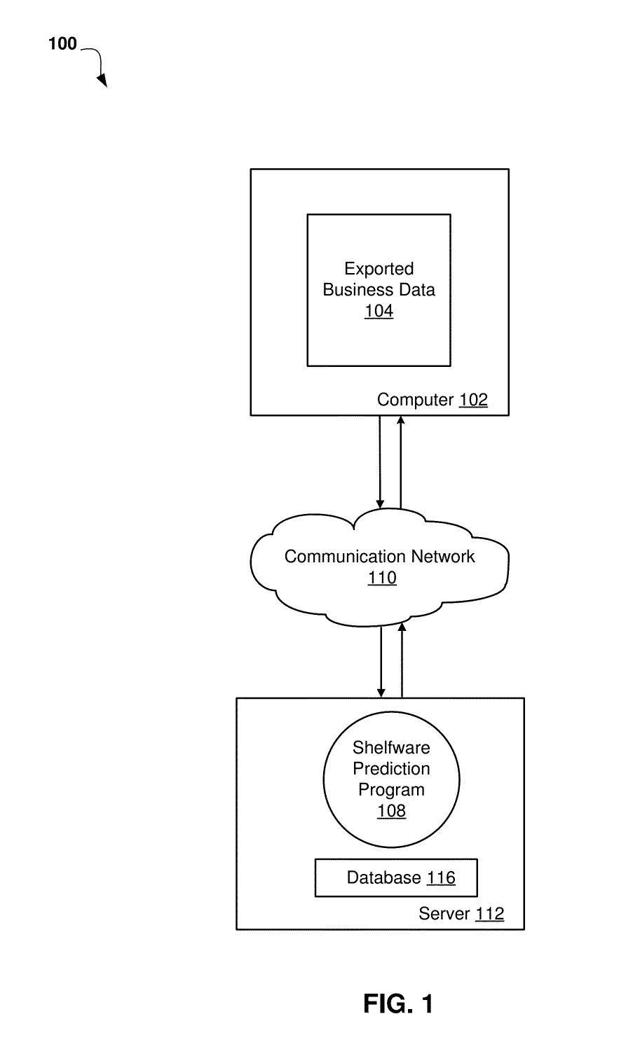

FIG. 1 illustrates a shelfware prediction system 100 in accordance with one embodiment of the present invention. The networked computer environment 100 may include a computer 102 that further includes exported business data 104, a server 112 that further includes a shelfware prediction program 108 and a database 116, and a communication network 110 interconnecting computer 102 and server 112. Generally, the networked computer environment 100 may include a plurality of computers 102 and servers 112.

The communication network 110 may include various types of communication networks, such as a wide area network (WAN), local area network (LAN), a telecommunication network, a wireless network, a public switched network and/or a satellite network, and may include connections, such as wire, wireless communication links, or fiber optic cables. In general, communication network 110 can be any combination of connections and protocols that will support communications between computer 102 and server 112, in accordance with embodiments of the invention.

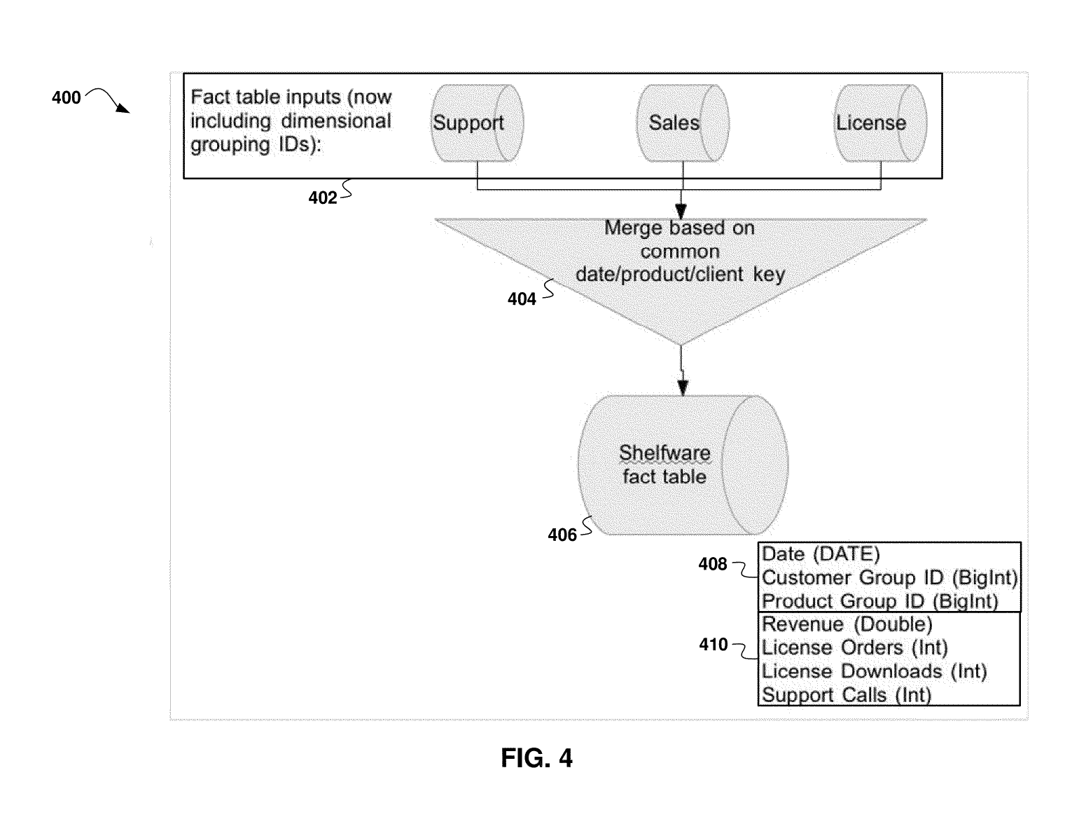

As will be discussed with reference to FIG. 4, server computer 112 may include internal components 800a and external components 900a, respectively and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing device capable of running a program and accessing a network.

Computer 102 represents the various sources of the exported business data 104 that is transmitted to server 112 for processing. This data may include software support data, software license data, and financial data from license entitlement systems, license management systems, license enforcement systems, compliance systems, customer support systems, sales data systems, and financial data systems within and external to the business enterprise.

Server 112 represents the computing environment that hosts shelfware prediction program 108. Server 112 receives the exported business data 104 transmitted by computer 102, which is then processed by shelfware prediction program 108. Server 112 may operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud.

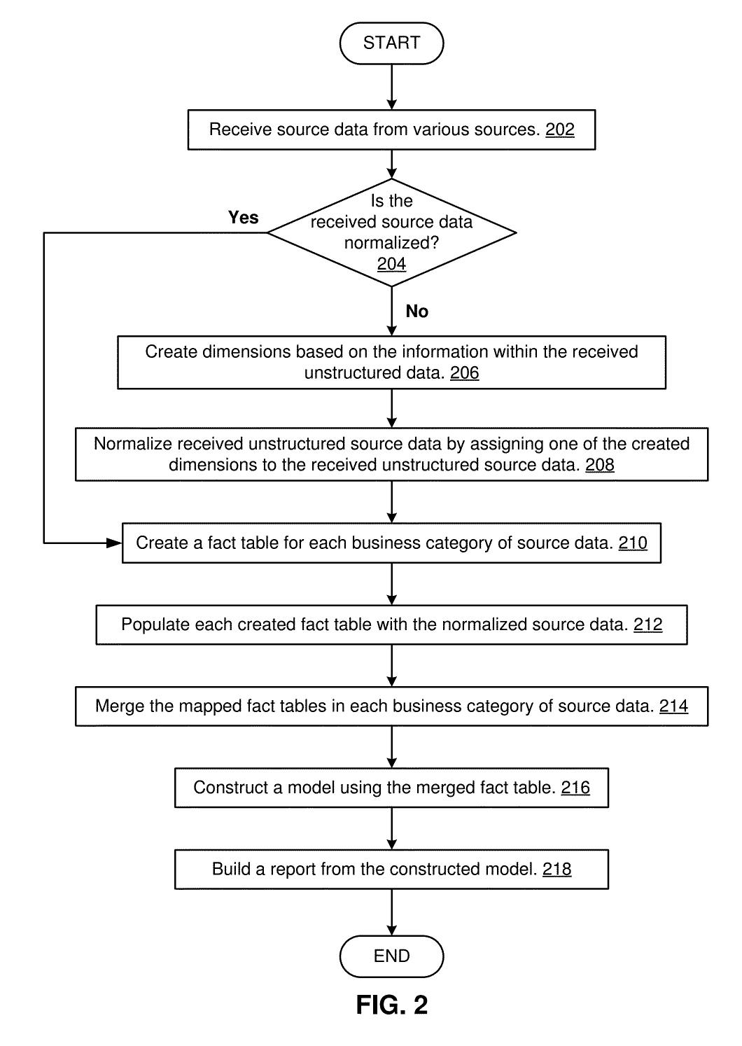

FIG. 2 is an operational flowchart illustrating the steps carried out by shelfware prediction program 108 to automatically import, correlate, and filter source data to identify patterns and trends in customer-related information that may infer installation and usage of purchased software. At 202, shelfware prediction program 108 may passively receive the business data 104, such as data tables, exported from the various sources, represented by computer 102. The received business data exported from the various sources may originate from various business categories, such as support data, license data, sales data, and financial data. The source data received from the various sources may be presented in different formats. For example, some data may be received in a relational database, such as IBM® DB2® (DB2® and all DB2-based trademarks and logos are trademarks or registered trademarks of International Business Machines Corporation and/or its affiliates), or a document of structured data, such as Microsoft Excel® (Microsoft Excel® and all Microsoft Excel-based trademarks and logos are trademarks or registered trademarks of Microsoft Corporation and/or its affiliates) worksheets, while other data may be received in a .txt extension text file.

At 204, shelfware prediction program 108 may determine whether the received source data is normalized into dimensions, or dimensional groupings. In various embodiments of the invention, the exported business data 104 is considered normalized, or structured, if the exported business data 104 is mapped so that the items of exported business data 104 correlate to the data source from which each item of exported business data 104 originated. A dimension may relate to a common attribute among a category of data, such as date data, product data, customer data, etc. For example, a fields of data may contain information relating to a product identification number. These fields of data may be assigned the same dimension since they display data with a common attribute. Other examples of common attributes include dates, customer names, customer identification numbers, and product names. Dimensions may be determined by analyzing the distinct data fields within the source data and arranging the unstructured source data into groupings of common attributes, such as date, customer, or product. For example, if a number of data fields relate to either a date, a week, a month, a quarter, or a year, then the shelfware prediction program 108 may create a date dimension. A dimensional grouping may relate to a number of data fields assigned to the same dimension. For example, if two fields of data that relate to a product part number, then the two fields of data may belong to a product dimension and may be considered to belong to a product dimensional grouping.

If the exported business data 104 is not normalized or structured into dimensional groupings (decision step 204, “No” branch), then, at 206, the shelfware prediction program 108 may create dimensions based on the information within the received unstructured exported business data 104.

At 208, the shelfware prediction program 108 may normalize the received unstructured exported business data 104 by assigning the received unstructured exported business data 104 to one of the created dimensions. Once the dimensions have been created (see step 206), the received unstructured exported business data 104 may be categorized so that the shelfware prediction program 108 may normalize the previously unrelatable exported business data 104. The shelfware prediction program 108 may normalize the unstructured exported business data 104 by replacing or adding fields, such as rows of data, columns of data, or tables of data, with a dimensional identification (ID) for a grouping containing the source value for a common field. For example, a relational database 116 may contain a column of data that portrays the year a transaction occurred. The column of data relating to the year a transaction occurred may be assigned a date dimensional ID. Assigning each field of data within the received unstructured exported business data 104 to a dimension may create a dimensional grouping of data. A dimensional grouping may be a group of exported business data 104 assigned to the same dimension. For example, all exported business data 104 assigned to a customer ID may be categorized in a customer ID dimensional grouping. As new exported business data 104 is received, the shelfware prediction program 108 may add new distinct entries to a particular dimensional grouping or create a new dimensional grouping based on the business category of the exported business data 104. A business category of exported business data 104 may relate to the business area that the item of exported business data 104 originated from. For example, data listing the number of license entitlements that a customer possesses may be categorized as license data since that data may originate from a license data source. Business categories may include license data, sales data, and support data.

At 210, the shelfware prediction program 108 may create a fact table for each business category of exported business data 104. A fact table is a tool used in data warehousing that links together facts about specific business processes. Once each piece of exported business data 104 is assigned a dimensional grouping ID, the shelfware prediction program 108 may create a fact table to portray dimensional grouping information within each category of exported business data 104. For example, if the exported business data 104 is categorized as support data, sales data, and license data and the dimensional groupings assigned to the exported business data 104 are date ID, product ID, and customer ID, then a separate fact table for the support data category, the sales data category, and the license data category may be created on which the exported business data 104 assigned a dimensional grouping of date ID, product ID, or customer ID may be populated. Therefore, in this example, a total of three fact tables may be created. The created fact tables may be saved in a repository, such as database 116 (FIG. 1).

At 212, the shelfware prediction program 108 may populate each created fact table where each field of data in each created fact table may contain either a dimensional ID or a measure. Fact tables contain foreign key information and measurement information. Foreign key information may be the dimensional grouping ID, such as date ID, product ID, and customer ID. Measurement information may be the factual information related to the support data, sales data, and licensing data, such as revenue numbers, license entitlements, license activations, and support tickets. Since multiple unrelated fields within the tables of exported business data 104 may relate to a particular category of exported business data 104, the shelfware prediction program 108 may populate the fact table for each business category with either a dimensional ID that relates to fields in the exported business data 104 or measurement data. For example, the shelfware prediction program 108 may receive five tables of sales data that contain data relating to either the date ID dimensional grouping, the product ID dimensional grouping, or the customer ID dimensional grouping. In order to relate the received sales data tables together, the shelfware prediction program 108 may populate the sales data fact table with dimensional information assigned either a date ID, a product ID, or a customer ID, or measurement information contained in the five received sales data tables.

At 214, the shelfware prediction program 108 may merge the populated fact tables for each category. Once the shelfware prediction program 108 populates the created fact tables, the previously unrelatable exported business data 104 may be merged together. For example, if three fact tables were created corresponding to the support data, sales data, and licensing data, the three fact tables may be merged together to create one fact table that displays the information previously presented in the support data fact table, the sales data fact table, and the licensing data fact table. Furthermore, the first fact table used while merging the fact tables may be the fact table that is the most important or useful when determining the presence of shelfware. For example, license data may be the most important information when determining whether a customer downloaded a product key. If the shelfware prediction program 108 is unable to detect that a product key was downloaded by a customer, then shelfware is likely present and the sales data fact table and support data fact table may be irrelevant.

At 216, the shelfware prediction program 108 may construct a dimensional model. The shelfware prediction program 108 may implement standard modeling techniques, such as a star schema, that may create the dimensional model. The merged fact table, the fact table for each exported business data category, and the normalized exported business data 104 may be used to create the dimensional model.

At 218, the shelfware prediction program 108 may build an interpretative report using the constructed dimensional model to display customer-related information, such as purchasing trends, license entitlements versus license activations, and support interactions. Once a dimensional model is constructed, the shelfware prediction program 108 may build a report using reporting tools, such as IBM® Cognos Business Intelligence, to interpret the information in the merged fact table, the fact table for each exported business data category, and the normalized exported business data 104. This interpretative report may be filtered and analyzed to identify customers possessing shelfware. For example, the report may be filtered for a specific product to determine whether the number of license downloads by a specific customer is greater than the number of license activations for that specific customer.

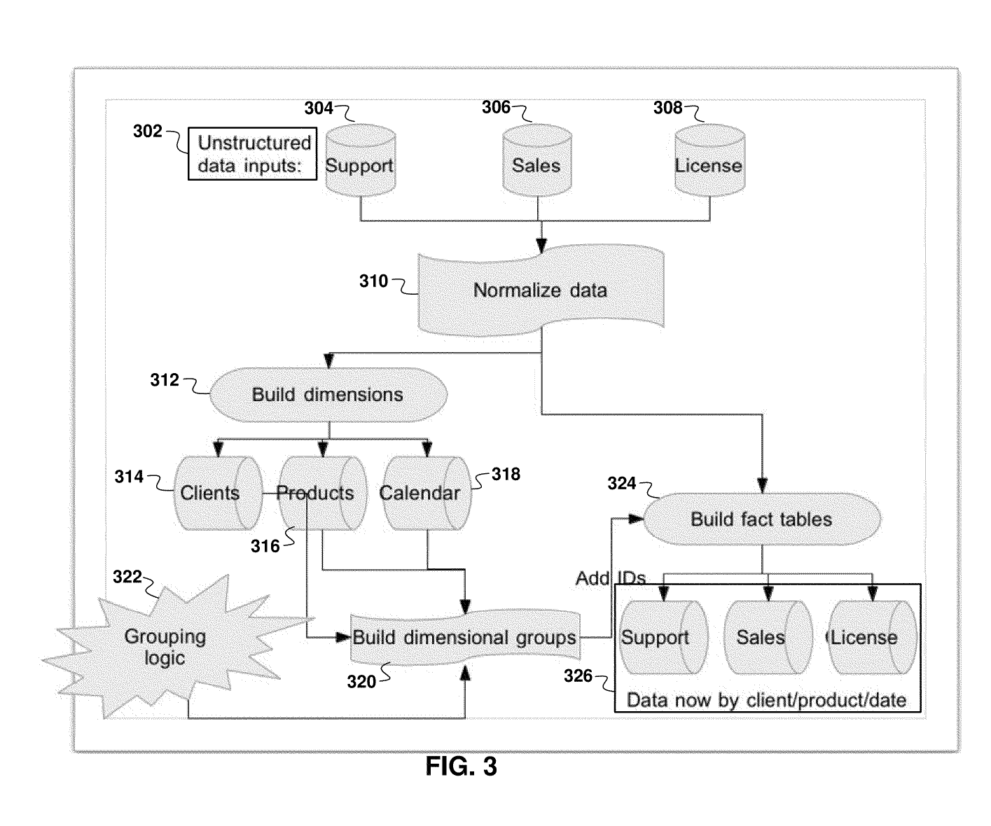

FIG. 3 illustrates a source data transformation, including normalization and grouping that may be performed by shelfware prediction program 108. A data transformation may be performed before creating the dimensional groupings when unstructured exported business data 104 is received from the various data sources in order to normalize the exported business data 104.

At 302, raw source data may be received by the shelfware prediction program 108 from various sources. As previously described, the various sources may include enterprise management systems, license entitlement systems, license management systems, license enforcement systems, compliance systems, customer support systems, sales data systems, and financial data systems. The raw exported business data 104 may be classified as support data 304, sales data 306, or licensing data 308. When the raw exported business data 104 is received, each individual table of data may not relate to other individual tables of data. However, manual inspection of the raw exported business data 104 may illustrate that the individual tables may be relatable with respect to certain fields, such as date fields, product fields, and customer fields.

At 310, the shelfware prediction program 108 may determine whether the business data 104 may be normalized. According to one implementation, if the business data 104 is received without established dimensional groupings, the business data 104 may require normalization and the method may continue to step 312. However, if the business data 104 is received with established dimensional groupings, the exported business data 104 may not require normalization and shelfware prediction program 108 may proceed directly to building fact tables (see step 324 below).

At 312, dimensional groupings, such as clients 314, products 316, and calendar 318, may be established by the shelfware prediction program 108 in order to normalize the raw unstructured data. Dimensions may be constructed using distinct entries from the exported business data 104 that are arranged into common groupings. Dimensional groupings may be created using common attributes among specific field data. For example, customer identification numbers, enterprise numbers, and international account numbers may be attributes that correspond to a customer dimension whereas component identification numbers, part numbers, and product family name may attributes that correspond to a product dimension. When new data is received, new distinct entries may be added to an existing dimensional grouping or a new dimensional grouping may be created depending on the newly received source data.

At 320, common fields within the raw, unstructured business data 104 may be normalized by replacing or adding in fields with a dimensional grouping identification (ID) for a grouping containing the source value for the common field. Furthermore, grouping logic 322 may be implemented to assist in building the dimensional groupings of exported business data 104. For example, fields containing information relating to a date may be replaced with a date grouping ID. By using the date grouping ID and the date dimensional grouping, the data may be viewable by date, week, month, quarter, or year. Similarly, fields containing customer data, such as customer names and customer numbers, may be replaced with a customer grouping ID. The customer grouping ID may link to a hierarchical view of the customer. For example, one customer grouping ID may relate to a domestic customer group or a global customer group. By using a low level customer grouping ID, the data may be grouped anyplace within the hierarchy. Additionally, fields containing product data may be assigned a product ID. However, product data may appear differently than customer data or date data. For example, some data sources may use a product name whereas other data sources may use a product part number. By implementing a product mapping table that uses a part number lookup feature or parses a product name string, product data that may be nearly unusable may be linked together and a product ID may be used. Furthermore, the product mapping table may map specific products to a standardized product grouping. For example, products within the IBM® Rational® Performance Tester (RPT) product line may simply be mapped to RPT rather than as a specific product.

At 324, fact tables may be constructed where each field within the fact table may be either a dimensional grouping ID, such as date ID, product ID, or customer ID, or measurement data. As previously described, a fact table is a tool used in data warehousing that links together facts about specific business processes. Fact tables contain two types of data: foreign key information that corresponds to dimensional tables and measurement data that contains facts. According to the present embodiment, the foreign key information may be the dimensional grouping ID that may be mapped to the exported business data 104. Furthermore, the measurement data with respect to shelfware prediction and software deployment detection may be revenue numbers, license entitlements, license activations, and help desk support tickets.

At 326, the support source data, sales source data, and license source data may be successfully structured into separate fact tables where each fact table categorizes data by client or customer, product, and date or calendar.

FIG. 4, an example 400 of the shelfware prediction program 108 merging grouped data so shelfware may be identified by dynamic patterns is provided. At 402, after the fact tables are constructed and mapped with common IDs, the previously unstructured data may be ready to merge.

At 404, depending on the basis and/or logic being implemented, the shelfware prediction program 108 may begin merging with any of the fact tables. The first fact table used in the merge algorithm may be the key in determining the presence of shelfware. For example, license data may be used as the key. If there is a customer ID, a date ID, or a product ID where no license data exists, then the present embodiment may not be able to determine if a customer has downloaded the product keys and any other data may be irrelevant. Therefore, beginning with the license data fact table, a merge may be performed with the finance or sales data fact table using the customer grouping, date grouping, and product grouping. When finance data exists for the same groupings, it may be merged with the license data. After merging the data, the license data and finance data for a common date, customer, or product may be aligned in one row. Similarly to the merge performed for license data and finance data, support data may be merged.

At 406, the merged fact tables may assist in detection of shelfware and software deployment. The merged fact table may contain dimensional grouping IDs 408, such as Date, Customer Group ID, and Product Group ID, and measurement data 410, such as revenue, license orders, license downloads, and support calls. Merging the data using common dimensions may flatten the previously disparate data so that a model may be constructed and a report may be built. Modeling the fact and dimension tables may be done using standard modeling techniques, such as a star schema. Furthermore, reports may be built using the model by implementing reporting tools, such as IBM® Cognos Business Intelligence.

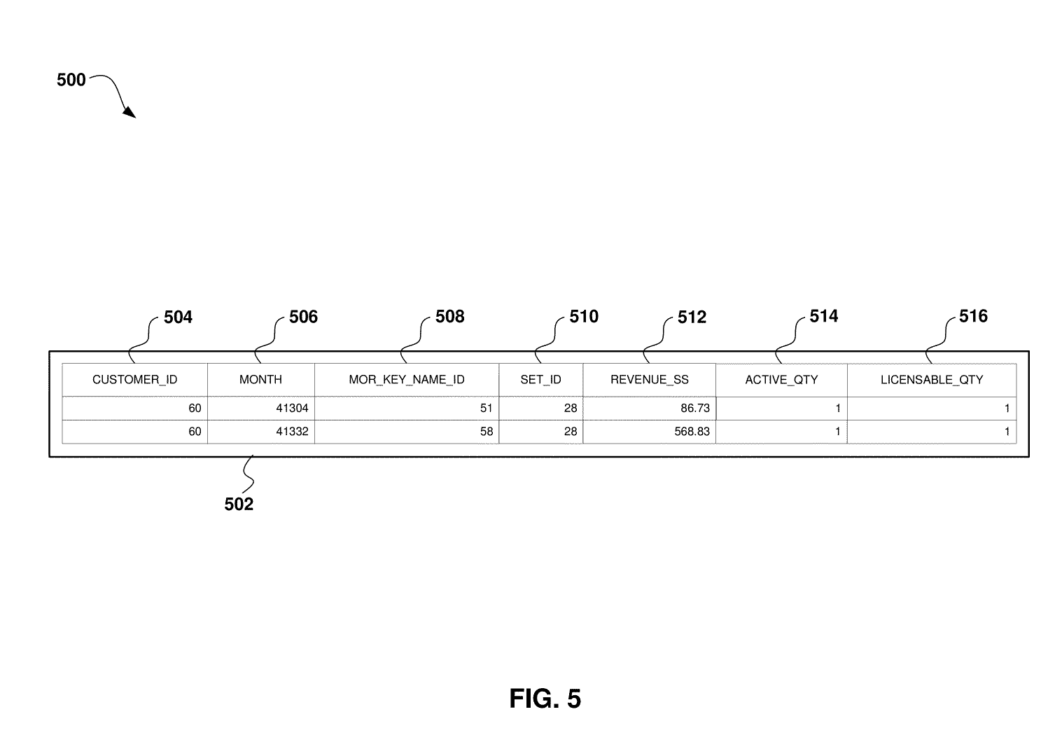

FIG. 5 illustrates a merged fact table 500, in accordance with one embodiment of the present invention. As previously described, implementations of the present embodiment may include the merging of the mapped fact tables in each category of exported business data 104 to create a merged fact table 502. The merged fact table 502 may be created by merging each of the support data fact table, sales data fact table, and license data fact table. The merged fact table 502 may contain dimensional grouping IDs. For example, a field may be listed as a dimensional grouping ID, such as the CUSTOMER_ID field 504. However, fields within the fact table may be named corresponding to the data within the field and still correspond to a dimensional grouping ID. For example, the MONTH field 506 may correspond to a date ID. Similarly, the MOR_KEY_NAME_ID field 508 may correspond to a product ID. Other fields, such as fields 510-516, may represent measures, such as revenue, license and support data.

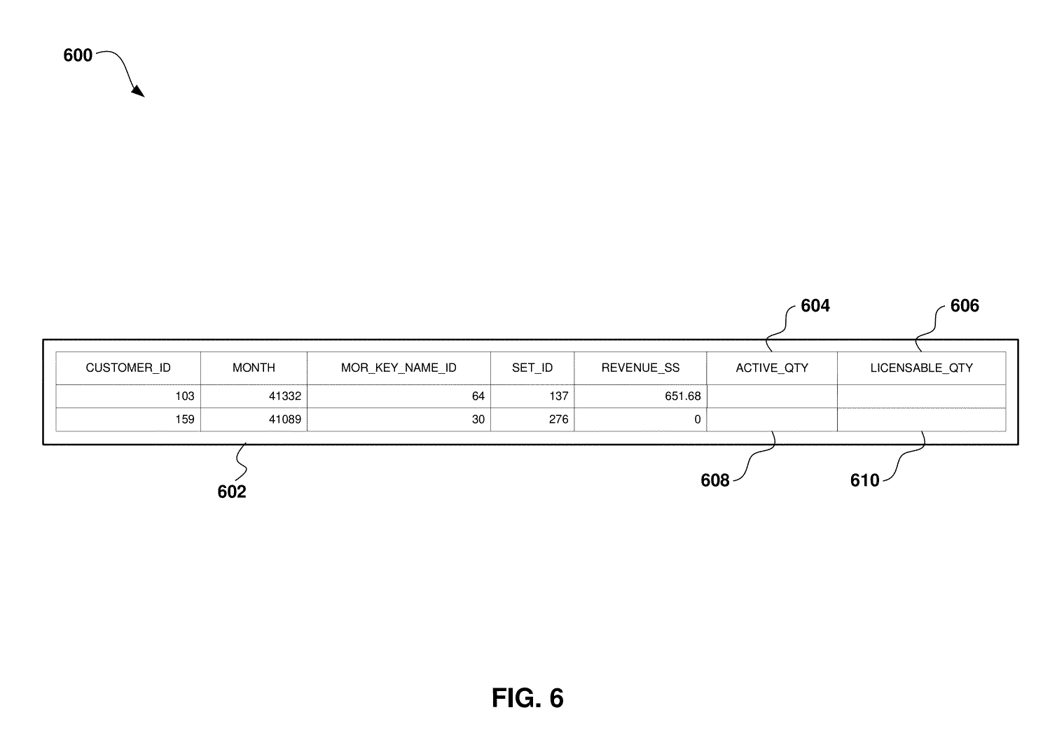

FIG. 6 illustrates a merged fact table 600 with blank fields of data, in accordance with one embodiment of the present invention. The merged fact table 602 may contain blank fields of data. For example, the ACTIVE_QTY field 604 and the LICENSABLE_QTY field 606 may contain blank data cells 608 and 610. Due to the common dimensional groupings for date ID, customer ID, and product ID, the present embodiment may be able to combine or aggregate measurement data when building a report. Therefore, any blank data fields within the merged fact table 602 may be supplemented or filled when the present embodiment builds a report.

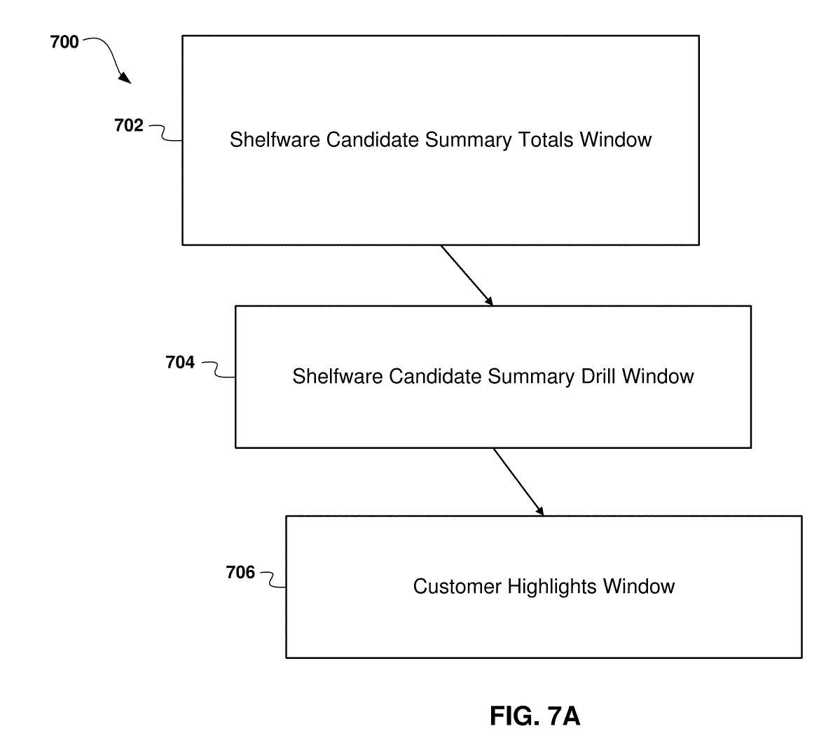

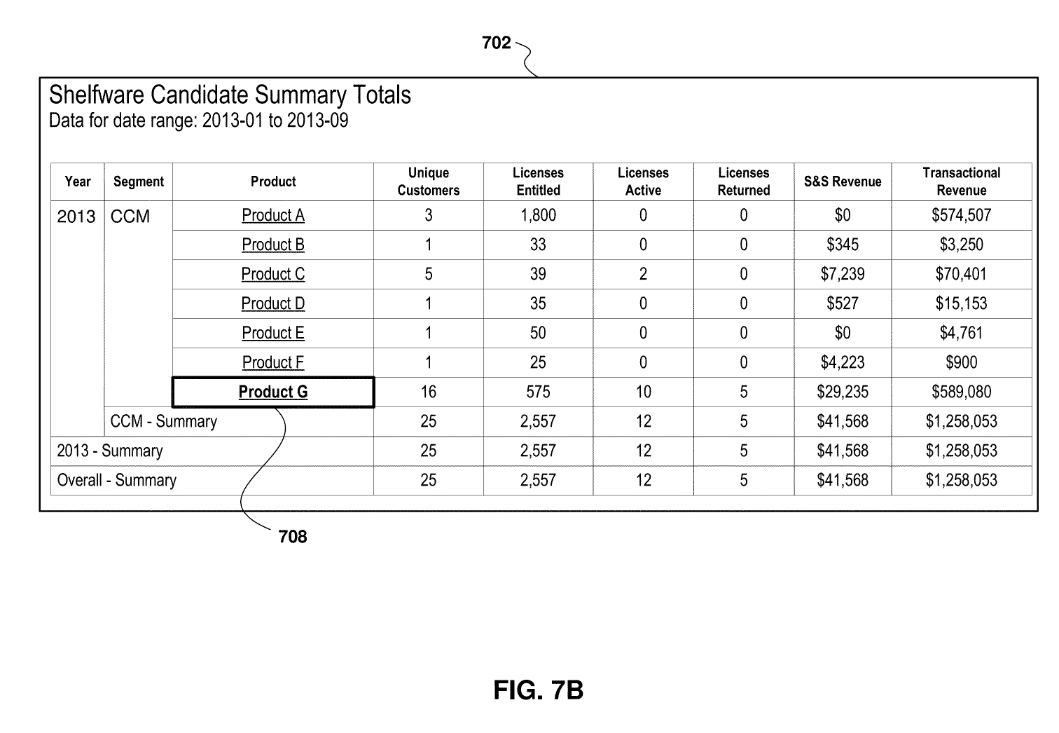

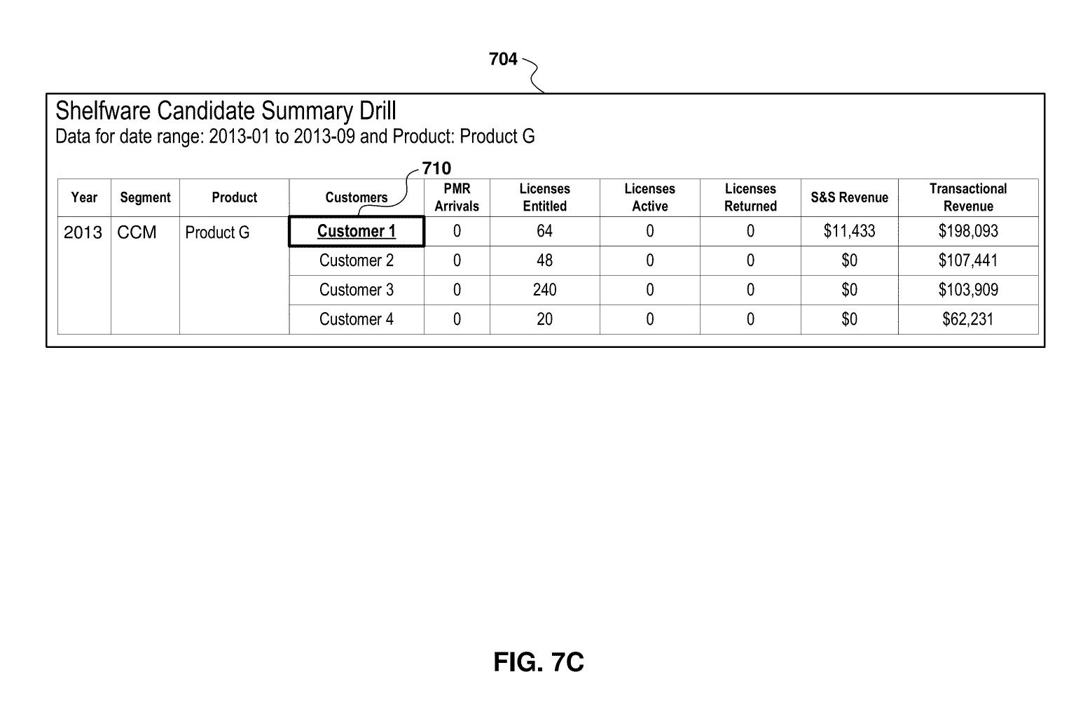

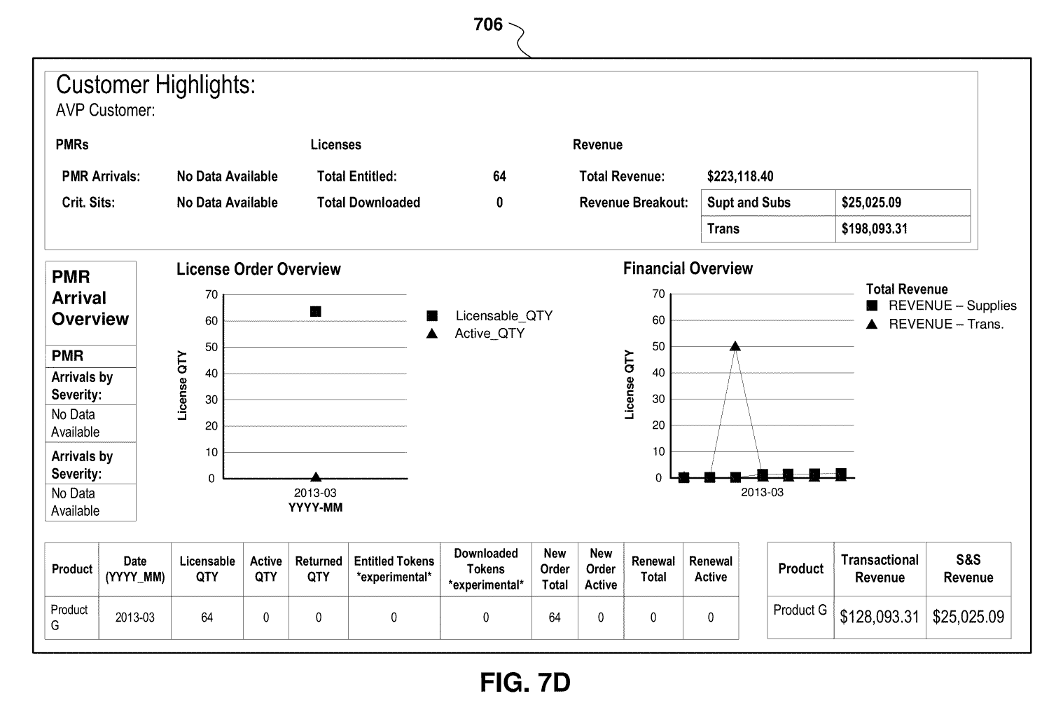

FIGS. 7A-7D illustrate an exemplary visualization 700 of a shelfware report identifying products and customers, in accordance one embodiment of the present invention. FIGS. 7A-7D illustrate how, after normalization of the exported business data 104 and merging the fact tables, the data may be filtered to show only customer groupings in a Shelfware Candidate Summary Totals Window 702. The Shelfware Candidate Summary Totals Window 702 may present information, such as unique customers, license entitlements, active licenses, returned licenses, and transactional revenue. The customer groupings may be created by filtering the data to show that customers, during a particular period of time, may have registered sales transactions and license entitlements of a particular product without logging any license downloads or support calls. Data may be viewed or drilled into at several levels. For example, a user of the report may select a product name 708 in the Shelfware Candidate Summary Totals Window 702. Selection of the product name 708 may present the user with a Shelfware Candidate Summary Drill Window 704, which may be a more detailed, product-specific report. The Summary Drill Window 704 may present information, such as customers that purchased the product, problem management record arrivals, entitled licenses per customer, active licenses per customer, returned licenses per customer, and transactional revenue per customer. Furthermore, the user may select customer name 710 in the Shelfware Candidate Summary Drill Window 704. Selection of the customer name 710 may present the user with a Customer Highlights Window 706, which may be a more detailed, customer-specific report related to the previously selected product name 708.

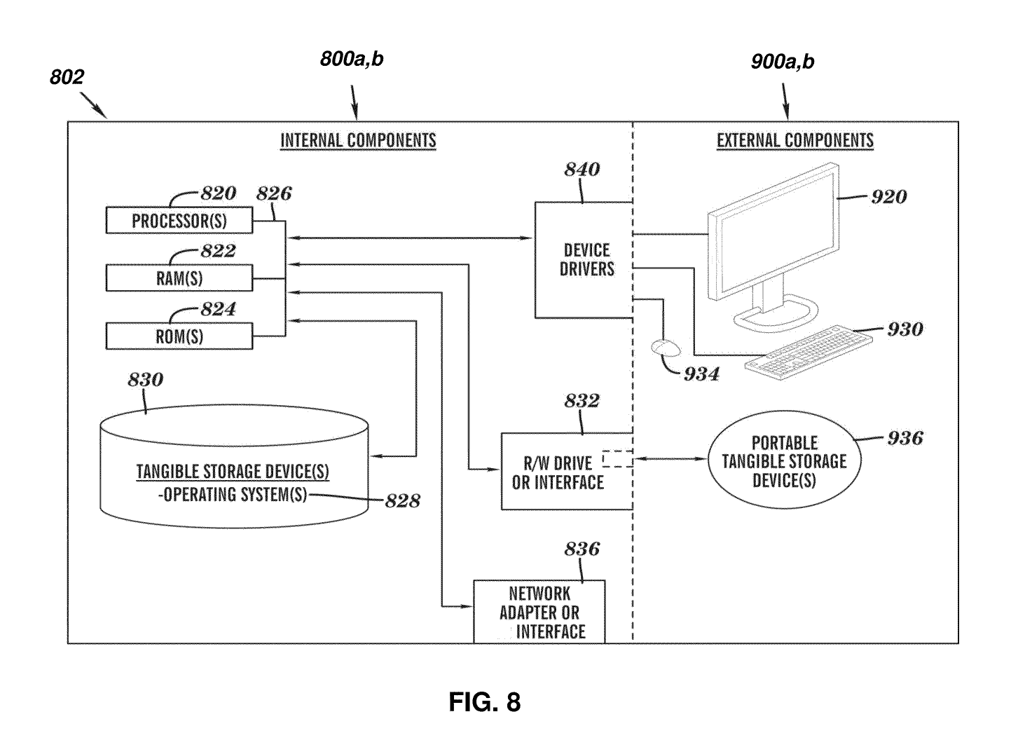

FIG. 8 is a block diagram 802 of internal and external components of computer 102 and server 112 depicted in FIG. 1 in accordance with an embodiment of the present invention. It should be appreciated that FIG. 8 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) may include respective sets of internal components 800 a, b and external components 900 a, b illustrated in FIG. 8. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 in client computer 102 (FIG. 1) and the shelfware prediction program 108 (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 8, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as shelfware prediction program 108 (FIG. 1), can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The shelfware prediction program 108 (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the shelfware prediction program 108 (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for detecting shelfware, the method comprising:
receiving a licensing data table and an exported business data table from a business data source, wherein the licensing data table and the exported business data table include a plurality of data fields associated with a plurality of business categories, wherein the plurality of business categories comprises licensing data and sales data;
creating a plurality of dimensions based on a common data attribute among the plurality of data fields,
wherein the plurality of dimensions includes a data ID, a customer ID, and a product ID,
wherein the common data attribute includes a plurality of enterprise numbers, a plurality of international account numbers, a plurality of part numbers, a plurality of product family numbers, and a plurality of product identification numbers;
structuring the received licensing data table and the received exported business data table by assigning each data field within the plurality of data fields to a dimension within the created plurality of dimensions;
populating a fact table for each of the plurality of business categories with each data field within the plurality of data fields based on each of the plurality of business categories from which each data field originated,
wherein the exported business data table comprises at least one of a license data table and a sales data table;
merging the populated fact table for each of the plurality of business categories based on a predetermined usefulness of each populated fact table when detecting shelfware,
wherein the populated fact table for each of the plurality of business categories contains a plurality of measurement information, the plurality of measurement information comprising at least one of a plurality of revenue numbers, a plurality of license entitlements, and a plurality of license activations;
constructing a dimensional model based on the merging the populated fact table for each of the plurality of business categories, the populated fact table for each of the plurality of business categories, and each data field within the structured licensing data table and the structured exported business data table; and
building an interpretative report to display a plurality of customer-related information based on the constructed dimensional model,
wherein the plurality of customer-related information includes a plurality of license entitlements versus a plurality of license activations.
